(19) United States
(12) Patent Application Publication
(10) Pub. No.: US 2023/0149925 A1
(43) Pub. Date: May 18, 2023

(54) LIQUID HANDLING DEVICE

(71) Applicant: Osler Diagnostics Limited, Oxford (GB)

(72) Inventors: Barry Lillis, Oxford (GB); Steven Green, Oxford (GB)

(21) Appl. No.: 17/915,996

(22) PCT Filed: Mar. 30, 2021
(86) PCT No.: PCT/EP2021/058363

§ 371 Date: Sep. 29, 2022

(30) Foreign Application Priority Data
Mar. 31, 2020 (GB) 2004723.9

(51) Int. Cl. B01L 3/00; G01N 35/10

(52) U.S. Cl. CPC B01L 3/502738; G01N 35/1016; B01L 3/50273; B01L 2200/0621; B01L 2200/0605; B01L 2400/049; B01L 2400/0655

(57) ABSTRACT

The present disclosure relates to a liquid handling device, methods of operating a liquid handling device, a method of performing a diagnostic test, a computer program and a system. In one aspect, a liquid handling device may comprise a main chamber; a sample chamber for receiving a sample, such as a saliva, blood or urine sample; one or more measurement chambers for performing measurements on the sample; a variable pressure source conduit for connecting the main chamber to a variable pressure source; a sample chamber conduit which fluidically connects the sample chamber to the main chamber; a sample chamber conduit valve for opening and closing the sample chamber conduit; a respective measurement chamber conduit for each measurement chamber, wherein each respective measurement chamber conduit fluidically connects the respective measurement chamber to the main chamber; and a respective measurement chamber conduit valve for opening and closing each respective measurement chamber conduit.

The present disclosure relates to a liquid handling device, methods of operating a liquid handling device, a method of performing a diagnostic test, a computer program and a system.

### BACKGROUND

Diagnostic tests, such as immunoassays, are often used for the detection of a specific analyte within a sample. For example, pairs of antibodies that can bind to an analyte to form a sandwich that is detectable by means of an enzyme or particulate label on one of the antibodies are well known and available for a wide range of different analytes of interest. Antibodies to a particular biomarker, such as testosterone or cortisol, may be used to test levels of these substances in saliva, blood or urine samples. The presence of the analyte is then determined using, for example, electrochemical measurements or fluorescence measurements.

Point-of-care detection brings a diagnostic test conveniently and immediately to a patient, allowing better and faster clinical decisions to be made. However, integration of diagnostic tests into a point-of-care device or system is challenging. Preparation of a sample for an immunoassay may require mixing of multiple solutions and reagents, with precise control of volumes and mixing times. Further, the device is ideally automated to obviate the need for a medical professional to be present.

Thus, there is a need to provide improved liquid handling devices capable of performing liquid handling operations for use in point-of-care diagnostic tests.

### SUMMARY

This summary introduces concepts that are described in more detail in the detailed description. It should not be used to identify essential features of the claimed subject matter, nor to limit the scope of the claimed subject matter.

In one aspect, a liquid handling device may comprise a main chamber; a sample chamber for receiving a sample, such as a saliva, blood or urine sample; one or more measurement chambers for performing measurements on the sample; a variable pressure source conduit for connecting the main chamber to a variable pressure source; a sample chamber conduit which fluidically connects the sample chamber to the main chamber; a sample chamber conduit valve for opening and closing the sample chamber conduit; a respective measurement chamber conduit for each measurement chamber, wherein each respective measurement chamber conduit fluidically connects the respective measurement chamber to the main chamber; and a respective measurement chamber conduit valve for opening and closing each respective measurement chamber conduit.

The variable pressure source conduit may be connected to the main chamber at the top of the main chamber, to reduce the likelihood of liquids in the main chamber entering the variable pressure source conduit and variable pressure source.

The main chamber and/or one or more of the one or more measurement chambers may comprise a reagent, as described below.

The liquid handling device may be for performing a diagnostic test on a sample.

The liquid handling device allows a sample to be transferred from the sample chamber into the main chamber by reducing the pressure in the main chamber relative to the sample chamber. Precise control of the volume of sample transferred into the main chamber is possible by controlling the pressure change in the main chamber. In the main chamber, the sample may react or mix with a reagent. The device allows the sample to be held in the main chamber for as long as necessary, for example for a duration of time needed to complete a reaction with a reagent. This may not be readily achievable with known fluid handling devices, such as conventional microfluidic devices.

The sample may then be transferred from the main chamber to the measurement chamber where it is held while a measurement is performed, for example as part of a diagnostic test such as an immunoassay. Again, precise control of the volume of sample transferred into the measurement chamber and residence time in the measurement chamber are possible.

The liquid handling device may be provided with or without a variable pressure source. That is to say that a variable pressure source may be integrated into the liquid handling device, but is preferably reversibly connected to the liquid handling device and as such may be provided separately.

A variable pressure source is a pressure source that can apply or provide both positive and negative pressure changes. For example, the variable pressure source may be a syringe and may be controlled by a stepper motor. Other variable pressure sources and ways of controlling variable pressure sources are known to the skilled person.

The liquid handling device is not limited to having only one main chamber or only one variable pressure source.

The main chamber may be arranged to receive a fluid from the sample chamber when the sample chamber conduit valve is open and a negative pressure change is applied to the main chamber via the variable pressure source conduit, and the one or more measurement chambers are arranged to receive the fluid from the main chamber when the respective measurement chamber conduit valves are open and a positive pressure change is applied to the main chamber via the variable pressure source conduit.

The liquid handling device may further comprise one or more reagent chambers; a respective reagent chamber conduit for each reagent chamber, wherein the respective reagent chamber conduit fluidically connects the respective reagent chamber to the main chamber; and a respective reagent chamber conduit valve for opening and closing each respective reagent chamber conduit.

The reagent chambers may store reagents such as an antibody or protein solution, antibody or protein powder, buffer solution, an enzyme substrate such as 3,3′,5,5′-tetramethylbenzidine “TMB,” and so on, for mixing or reacting with the sample in order to facilitate a measurement on the sample in the measurement chamber, for example to perform a diagnostic test on the sample.

The reagents in the reagent chambers may be readily mixed with the sample by controlling pressure changes in the liquid handling device. By providing a main chamber surrounded by one or more reagent chambers, the device facilitates complex mixing operations, for example operations with multiple steps each requiring precise volume control and timing that may not be readily achieved using known fluid handling devices.

A reagent chamber may also be known as an assay chamber.

The one or more measurement chambers may comprise a first measurement chamber for performing a first measurement on the sample and a second measurement chamber for performing a second measurement on the sample. As such, the liquid handling device further comprises a first respective measurement chamber conduit which fluidically connects the first measurement chamber to the main chamber; a second respective measurement chamber conduit which fluidically connects the second measurement chamber to the main chamber; a first respective measurement chamber conduit valve for opening and closing the first respective measurement chamber conduit; and a second respective measurement chamber conduit valve for opening and closing the second respective measurement chamber conduit.

As such, a single liquid handling device may be configured to receive only one sample in the sample chamber yet perform multiple measurements or diagnostic tests for determining multiple properties of the sample.

The one or more reagent chambers may comprise one or more first dedicated reagent chambers for reagents to be used only in a diagnostic test to be performed in the first measurement chamber, one or more second dedicated reagent chambers for reagents to be used only in a diagnostic test to be performed in the second measurement chamber, and one or more shared reagent chambers for reagents to be used in the diagnostic tests to be measured in both the first and second measurement chambers.

Ordinarily, separate measurement chambers would each require their own separate reagent sources, however, by providing a shared reagent chamber that provides a reagent, such as a buffer solution, common to two separate diagnostic tests or measurements, a more compact liquid handling device may be provided. At the same dedicated reagent chambers store reagents, such as specific antibodies or proteins, that may be selectively mixed with the sample for particular diagnostic tests or measurements, providing the device with a broader range of functionality.

The liquid handling device comprising one or more reagent chambers may further comprise a mixing chamber for mixing the sample with a reagent from one of the one or more reagent chambers. As such, the device also comprises a mixing chamber conduit, wherein the mixing chamber conduit fluidically connects the mixing chamber to the main chamber; and a mixing chamber conduit valve for opening and closing the mixing chamber conduit.

Once a reagent is combined with the sample, the resulting combination may be shuttled (transferred back and forth) between the main chamber and mixing chamber to accelerate mixing of the reagent and sample (homogenise the reagent and sample) or accelerate dissolution of the reagent in the sample or other liquid.

The liquid handling device may further comprise a waste chamber and a waste chamber conduit, wherein the waste chamber conduit fluidically connects the waste chamber to the main chamber.

The waste chamber may be used to safely store excess sample and/or reagents, for example after the liquid handling device has been used to perform a measurement on the sample. Further, sample may be overprovided to the main chamber, and then transferred into another chamber such as a mixing chamber in a precise quantity, while the excess sample is expelled to the waste chamber. The precisely measured sample can then be returned to the main chamber with a precise known volume.

The liquid handling device may further comprise a waste chamber conduit valve for opening and closing the waste chamber conduit. Alternatively, the waste chamber conduit may fluidically connect the waste chamber to the main chamber via the measurement chamber. Thus, sample can be transferred directly from the measurement chamber to the waste chamber after a measurement has been performed.

At least one of the one or more measurement chambers may comprise a plurality of electrodes. The plurality of electrodes may be for performing an electrochemical measurement. Alternatively or in addition, at least one of the one of more measurement chambers may comprise an element for performing an optical measurement, such as a window. In general, each measurement chamber may be configured for any type of measurement: electrochemical, optical (photometry, fluorescence, imaging), magnetic (magnetic field sensor) and/or thermometric (temperature sensor).

Each conduit valve may be a pinch valve. A pinch valve may be operated by an external actuator that selectively applies pressure to the pinch valve to open or close it. Optionally, the conduit valves may be configured in a circular array, so that they can be operated by an actuator with a circular array of actuation elements. A pinch valve is a valve which uses a pinching effect to obstruct fluid flow.

The conduit valves of the devices described above may be configured such that only one valve is open at any given time. The conduit valves of the devices described above may be closed by default.

The chambers of the liquid handling device may comprise gas exchange means, such as holes, air vents or a breathable sealing film. A breathable sealing film may be a hydrophobic porous sealing film with medical-grade adhesive, such as those that are available from AeraSeal® or Breathe-Easy® for cell and tissue culture where gas exchange is required. The gas exchange means is for allowing air or any other ambient gas to enter and exit each chamber to balance a pressure change resulting from liquid (such as a sample or reagent) entering the respective chambers, although this is not essential. Depending on the chamber, the chamber may be opened to the air (for example have an unsealed top), the chamber may have an air vent open to the outside, a fluid port or channel may act as an air vent, or the chamber could be vented via a venting valve connected to the pressure source conduit (for example, in the case of a main chamber).

The liquid handling device may be made from conventional materials known to the skilled person such as glass, silicon, polydimethylsiloxane (PDMS) or any thermoplastic (such as polymethylmethacrylate (PMMA), polycarbonate (PC), cyclic olefin copolymer (COO), polypropylene (PP)) using conventional methods such as chemical etching, laser etching, routing or moulding.

In another aspect, a method of operating a liquid handling device as described above may comprise opening the sample chamber conduit valve; reducing a pressure in the main chamber relative to the sample chamber; closing the sample chamber conduit valve; opening one of the respective measurement chamber conduit valves; and increasing a pressure in the main chamber relative to the respective measurement chamber.

Thus, after a sample has been inserted into the sample chamber, the sample may be transferred from the sample chamber to the main chamber, and then from the main chamber to the measurement chamber.

Pressure changes are applied via the variable pressure source conduit of the liquid handling device, and may be applied using a variable pressure source, such as a syringe or any other means suitable for applying positive and negative pressure changes, connected to the variable pressure source conduit.

The method of operating a liquid handling device, wherein the liquid handling device comprises one or more reagent chambers as described above, may further comprise opening the reagent chamber conduit valve corresponding to one of the one or more reagent chambers; reducing a pressure in the main chamber relative to the one of the one or more reagent chambers; and closing the reagent chamber conduit valve corresponding to the one of the one or more reagent chambers.

Thus, a reagent may be transferred from a reagent chamber to the main chamber.

The method may further comprise, prior to reducing a pressure in the main chamber relative to the one of the one or more reagent chambers, increasing a pressure in the main chamber relative to the one of the one or more reagent chambers in order to transfer a liquid in the main chamber, such as a sample, into the one of the one or more reagent chambers. Thus, if the one of the one or more reagent chambers comprises a dried or powdered reagent, a liquid in the main chamber can be used to suspend or dissolve the reagent and then transfer it into the main chamber.

When the liquid handling device comprises a mixing chamber as described above, the method of operating a liquid handling device may further comprise opening the mixing chamber conduit valve; increasing a pressure in the main chamber relative to the mixing chamber; reducing a pressure in the main chamber relative to the mixing chamber and closing the mixing chamber conduit valve.

Thus, a mixture, such as a mixture of a sample and a reagent, may be shuttled between the main chamber and mixing chamber to accelerate mixing of the reagent and sample (e.g. homogenise reagent and sample) or accelerate dissolution of the reagent in the sample.

The method may further comprise repeating increasing a pressure in the main chamber and reducing a pressure in the main chamber one or more times before closing the mixing chamber conduit valve.

When the liquid handling device comprises a waste chamber, waste chamber conduit and waste chamber conduit valve as described above, the method of operating a liquid handling device may further comprise opening the waste chamber conduit valve; increasing a pressure in the main chamber relative to the waste chamber; and closing the waste chamber conduit valve. The method may yet further comprise closing the one of the respective measurement chamber conduit valves before opening the waste chamber conduit valve.

Thus, liquid in the main chamber may be transferred to the waste chamber where it may be safely stored, for example after the liquid handling device has been used to perform a measurement on the sample.

When the liquid handling device comprises a waste chamber and waste chamber conduit fluidically connecting the waste chamber to the main chamber via the measurement chamber the method of operating a liquid handling device may further comprise increasing a pressure in the main chamber relative to the waste chamber after performing a measurement on the sample.

Thus, liquid in the measurement chamber may be transferred to the waste chamber where it may be safely stored, for example after the liquid handling device has been used to perform a measurement on the sample.

When the one or more measurement chambers comprise a plurality of electrodes, the method of operating a liquid handling device may further comprise performing an electrochemical measurement on a sample using the plurality of electrodes.

When each conduit valve of the liquid handling device is a pinch valve, the method of operating a liquid handling device may further comprise opening or closing at least one of the pinch valves by operating an actuator. The pinch valves may be configured to only open one-at-a-time (i.e. only one pinch valve is open at any one time).

As will be understood, the methods described above can be performed in combination with each other, and in many different orders or multiple times, as required for a given diagnostic test. The order of each method is not limited to the order in which the features are presented above, and one method need not be completed before another method is performed. For example, a method for mixing may be performed after a sample and reagent are introduced into the main chamber but before at least a portion of the sample is transferred to the measurement chamber.

In another aspect, a method of performing a diagnostic test using a liquid handling device as described above comprises filling the sample chamber with a sample and performing one or more of the methods described above. Optionally, the liquid handling device comprises one or more reagent chambers and each of the one or more reagent chambers comprises a respective reagent for the diagnostic test.

In another aspect, a method of operating a liquid handling device may comprise opening one of the respective auxiliary chamber conduit valves and increasing or reducing the pressure in the main chamber relative to the respective auxiliary chamber by a predetermined amount, thereby enabling transfer of a metered volume of a liquid between the main chamber and the respective auxiliary chamber. As such, the liquid handling device comprises a main chamber; one or more auxiliary chambers; a respective auxiliary chamber conduit for each auxiliary chamber, wherein each auxiliary chamber conduit fluidically connects the respective auxiliary chamber to the main chamber and a respective auxiliary chamber conduit valve for opening and closing each respective auxiliary chamber conduit. The use of predetermined pressure changes enables transfer of precise volumes of liquid.

Increasing or reducing the pressure in the main chamber relative to the respective auxiliary chamber by a predetermined amount may comprise applying a predetermined pressure change for a predetermined period of time.

When the pressure in the main chamber is increased, transfer of a metered volume of a liquid from the main chamber to the respective auxiliary chamber is enabled. When the pressure in the main chamber is reduced, transfer of a metered volume of a liquid from the respective auxiliary chamber to the main chamber is enabled.

When the liquid handling device further comprises a waste chamber; a waste chamber conduit, wherein the waste chamber conduit fluidically connects the waste chamber to the main chamber, and a waste chamber conduit valve for opening and closing the waste chamber conduit, the method may further comprise closing the one of the respective auxiliary chamber conduit valves; opening the waste chamber conduit valve and increasing a pressure in the main chamber relative to the waste chamber thereby enabling transfer of liquid in the main chamber to the waste chamber. The method may yet further comprise closing the waste chamber conduit valve.

In this way, sample may be overprovided to the main chamber, and then transferred into another chamber such as a mixing chamber in a precise quantity, while the excess sample is expelled to the waste chamber. The precisely measured sample can then be returned to the main chamber with a precisely known volume.

In another aspect, a computer program may comprise computer-executable instructions which, when executed by a system, cause the system to perform the any of the methods described above.

In another aspect, a system may comprise a processor configured to execute a computer program comprising computer-executable instructions which, when executed by a system, cause the system to perform any of the methods described above.

A system may be a point-of-care system or diagnostic system and/or may be for performing a diagnostic test on a sample.

The system may further comprise one or more of a variable pressure source configured to connect to a liquid handling device; a variable pressure source controller to control the variable pressure source; an actuator configured to selectively open or close each of the plurality of pinch valves and a liquid handling device as described above. The processor may be configured to control the variable pressure source controller to control the variable pressure source in accordance with any of the above described methods. The system may further comprise memory for storing the computer program.

The system may comprise an electrovalve (also known as an electrically operated valve) directly connected to the variable pressure source in a separate pneumatic circuit. The electrovalve may be configured as a venting valve to allow the pressure source to be vented between consecutive operations. That is, the electrovalve may be configured to selectively connect the pressure source to the ambient atmosphere, so that the pressure source can be vented in preparation for an operation. For example, if the pressure source is a syringe pump, when the syringe pump is connected to the ambient atmosphere by the electrovalve, the syringe position may be moved or changed in preparation for an operation without applying a pressure change to the liquid handling device. The electrovalve may also be used to vent pressure from the chambers of the device. For example, the main chamber may be connected to the syringe pump and the vent valve circuit via a T-shape pneumatic connector.

### BRIEF DESCRIPTION OF THE DRAWINGS

Embodiments of the present invention will now be described, by way of example only, with reference to the accompanying drawings, in which:

FIG. 1 illustrates a liquid handling device comprising a main chamber, sample chamber, variable pressure source and one or more measurement chambers;

FIG. 2 illustrates a liquid handling device according to FIG. 1, further comprising one or more reagent chambers;

FIG. 3 illustrates a liquid handling device according to FIG. 1, comprising first and second measurement chambers;

FIG. 4 illustrates a liquid handling device according to FIG. 3, further comprising first and second dedicated reagent chambers and a shared reagent chamber;

FIG. 5 illustrates a liquid handling device according to FIG. 1, further comprising a mixing chamber and a one or more dedicated reagent chambers;

FIG. 6 illustrates a liquid handling device according to FIG. 1, further comprising a waste chamber;

FIG. 7 illustrates a liquid handling device according to FIG. 1, further comprising a waste chamber;

FIG. 8 illustrates a liquid handling device comprising a circular array of pinch valves;

FIG. 9 illustrates a flow diagram for a method for transferring sample to a measurement chamber;

FIG. 10 illustrates a flow diagram for a method for transferring reagent to a main chamber;

FIG. 11 illustrates a flow diagram for a method for mixing liquids;

FIG. 12 illustrates a flow diagram for a method for transferring liquid to a waste chamber;

FIG. 13 illustrates a flow diagram for a method for performing an electrochemical measurement;

FIG. 14 illustrates a flow diagram for a method of operating a liquid handling device;

FIG. 15 illustrates a flow diagram for a method of operating a liquid handling device;

FIG. 16 illustrates a flow diagram for a method of performing a diagnostic test;

FIGS. 17A and 17B illustrate flow diagrams for methods of metering;

FIG. 18 illustrates a flow diagram for a method of metering;

FIG. 19 illustrates a diagnostic system; and

FIG. 20 illustrates a block diagram of a diagnostic system.

### DETAILED DESCRIPTION

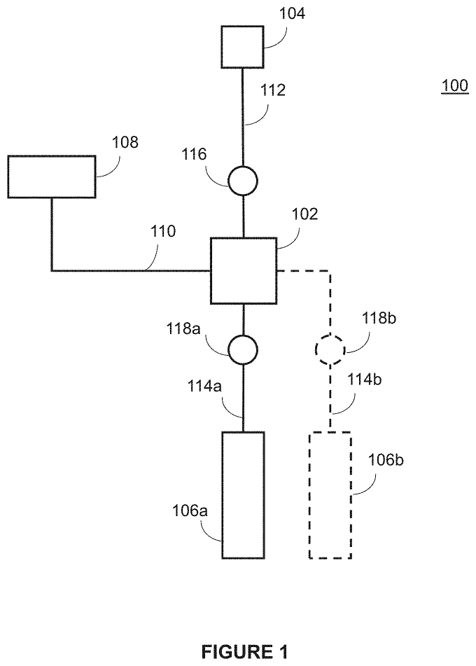

FIG. 1 illustrates a liquid handling device 100. The liquid handling device 100 comprises a main chamber 102; a sample chamber 104 for receiving a sample; one or more measurement chambers 106a/106b for performing measurements on the sample; a variable pressure source conduit 110 connecting the main chamber 102 to a variable pressure source 108; a sample chamber conduit 112 which fluidically connects the sample chamber 104 to the main chamber 102; a sample chamber conduit valve 116 for opening and closing the sample chamber conduit 112; a respective measurement chamber conduit 114a/114b for each measurement chamber 106a/106b, wherein each respective measurement chamber conduit 114a/114b fluidically connects the respective measurement chamber 106a/106b to the main chamber 102; and a respective measurement chamber conduit valve 118a/118b for opening and closing each respective measurement chamber conduit 114a/114b. The variable pressure source conduit 110 is connected to the main chamber 102 at the top of the main chamber.

The main chamber 102 is arranged to receive a fluid from the sample chamber 104 when the sample chamber conduit valve 116 is open and a negative pressure change is applied to the main chamber 102 via the variable pressure source conduit 110. Further, the one or more measurement chambers 106a/106b are arranged to receive the fluid from the main chamber 102 when the respective measurement chamber conduit valves 118a/118b are open and a positive pressure change is applied to the main chamber 102 via the variable pressure source conduit 110.

The measurement chambers 106a/106b each comprise a plurality of electrodes 138 (not illustrated in FIG. 1).

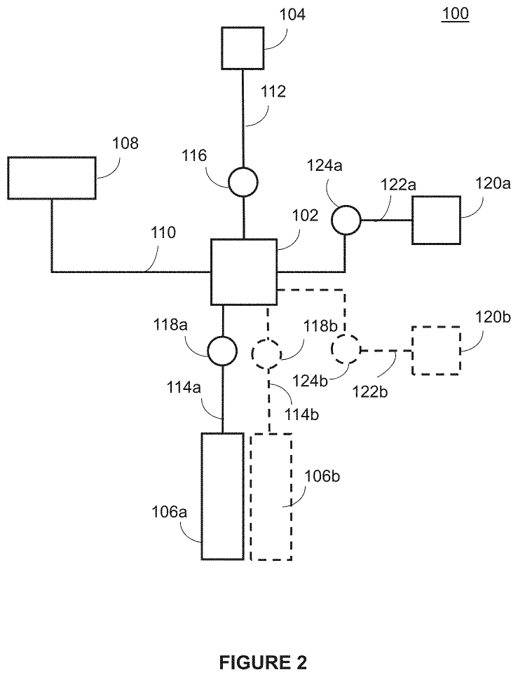

FIG. 2 illustrates a liquid handling device 100 as illustrated in FIG. 1, further comprising one or more reagent chambers 120a/120b; a respective reagent chamber conduit 122a/122b for each reagent chamber 120a/120b, wherein the respective reagent chamber conduit 122a/122b fluidically connects the respective reagent chamber 120a/120b to the main chamber 102; and a respective reagent chamber conduit valve 124a/124b for opening and closing each respective reagent chamber conduit 122a/122b.

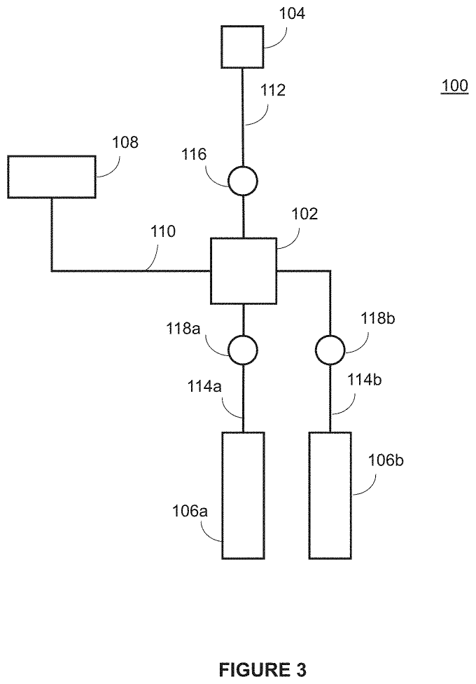

FIG. 3 illustrates a liquid handling device 100 as illustrated in FIG. 1, further comprising two measurement chambers 106a/106b. The two measurement chambers 106a/106b are known as a first measurement chamber 106a for performing a first measurement on the sample and a second measurement chamber 106b for performing a second measurement on the sample. The liquid handling device 100 further comprises a first respective measurement chamber conduit 114a which fluidically connects the first measurement chamber 106a to the main chamber 102; a second respective measurement chamber conduit 114b which fluidically connects the second measurement chamber 106b to the main chamber 102; a first respective measurement chamber conduit valve 118a for opening and closing the first respective measurement chamber conduit 114a; and a second respective measurement chamber conduit valve 118b for opening and closing the second respective measurement chamber conduit 114b.

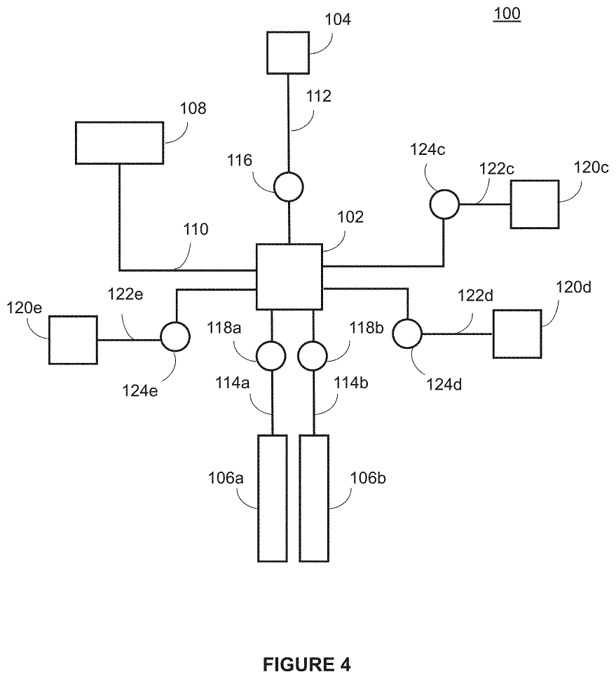

FIG. 4 illustrates a liquid handling device 100 as illustrated in FIG. 3, further comprising first and second dedicated reagent chambers 120c/120d and a shared reagent chamber 120e with respective conduits 122c/122d/122e and conduit valves 124c/124d/124e.

The first dedicated reagent chamber 120c is for reagents to be used only in a diagnostic test to be performed in the first measurement chamber 106a, the second dedicated reagent chamber 120d is for reagents to be used only in a diagnostic test to be performed in the second measurement chamber 106b, and the shared reagent chamber 120e is for reagents to be used in diagnostic tests to be measured in both the first and second measurement chambers 106a/106b.

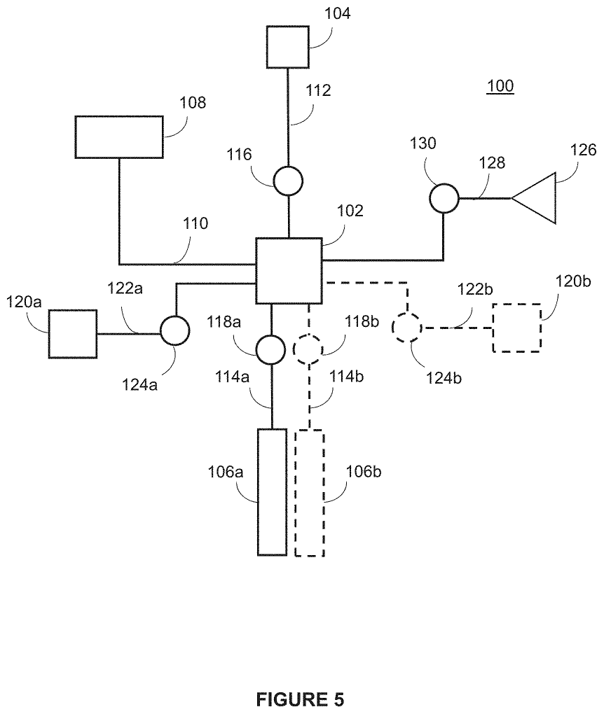

FIG. 5 illustrates a liquid handling device 100 as illustrated in FIG. 2, further comprising a mixing chamber 126 for mixing a sample with a reagent from one of one or more reagent chambers 120a/120b; a mixing chamber conduit 128, wherein the mixing chamber conduit 128 fluidically connects the mixing chamber 126 to the main chamber 102; and a mixing chamber conduit valve 130 for opening and closing the mixing chamber conduit 128.

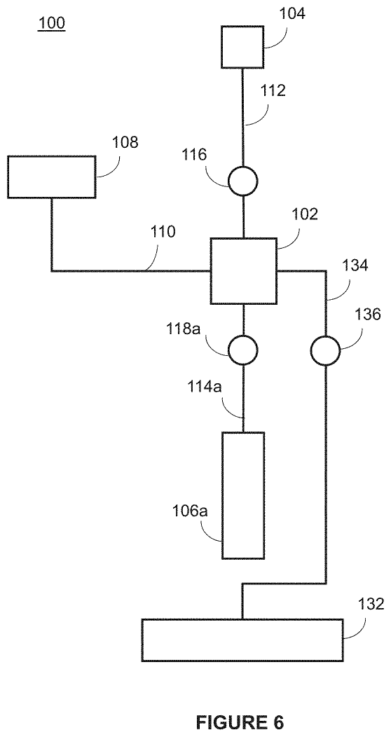

FIG. 6 illustrates a liquid handling device 100 as illustrated in FIG. 1, further comprising a waste chamber 132 and a waste chamber conduit 134, wherein the waste chamber conduit 134 fluidically connects the waste chamber 132 to the main chamber 102. The liquid handling device 100 further comprises a waste chamber conduit valve 136 for opening and closing the waste chamber conduit 134.

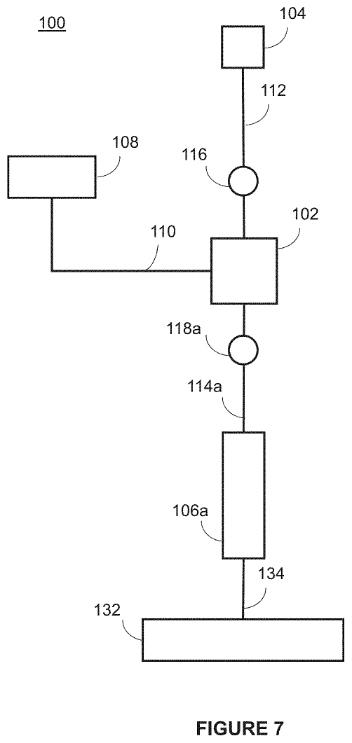

FIG. 7 illustrates a liquid handling device 100 as illustrated in FIG. 1, further comprising a waste chamber 132 with a different configuration to that of FIG. 6, wherein a waste chamber conduit 134 fluidically connects the waste chamber 132 to the main chamber 102 via the measurement chamber 106a. In contrast to the liquid handling device 100 illustrated in FIG. 6, no valve for controlling flow in the waste chamber conduit 134 is provided.

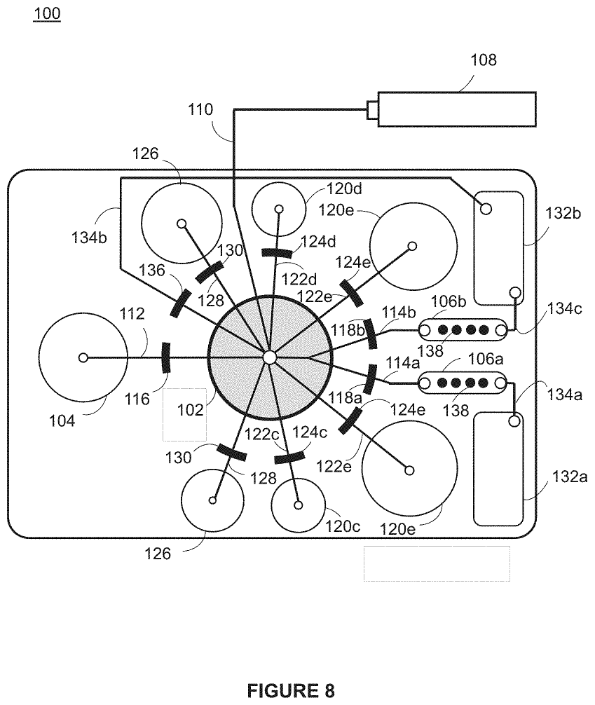

FIG. 8 illustrates a liquid handling device 100 as illustrated in FIG. 3, further comprising a first dedicated reagent chamber 120c for a reagent to be used only in a diagnostic test to be performed in a first measurement chamber 106a; a second dedicated reagent chamber 120d for a reagent to be used only in a diagnostic test to be performed in the second measurement chamber 106b; two shared reagent chambers 120e for reagents to be used in the diagnostic tests to be measured in both the first and second measurement chambers 106a/106b; and two mixing chambers 126. Conduits 122c/122d/122e/128 and conduit valves 124c/124d/124e/130 for the corresponding chambers are provided.

The liquid handling device 100 further comprises a first waste chamber 132a and a second waste chamber 132b. A first waste chamber conduit 134a fluidically connects the first waste chamber 132a to the first measurement chamber 106a. A second waste chamber conduit 134b fluidically connects the second waste chamber 132b to the main chamber 102 and a third waste chamber conduit 134c fluidically connects the second waste chamber 132b to the second measurement chamber 106b. A second waste chamber conduit valve 136 is configured to open and close the second waste chamber conduit 134b.

The variable pressure source conduit 110 is connected to a variable pressure source 108. The conduit valves are pinch valves and are configured in a circular array. Each measurement chamber 106a/106b comprises a plurality of electrodes 138.

The chambers of the liquid handling device 100 comprise gas exchange holes for allowing air or any other ambient gas to enter and exit each chamber to balance a pressure change resulting from liquid (such as sample or reagent) entering the respective chambers. The gas exchange holes are not essential, while other gas exchange means such as air vents can be used instead or in addition to holes.

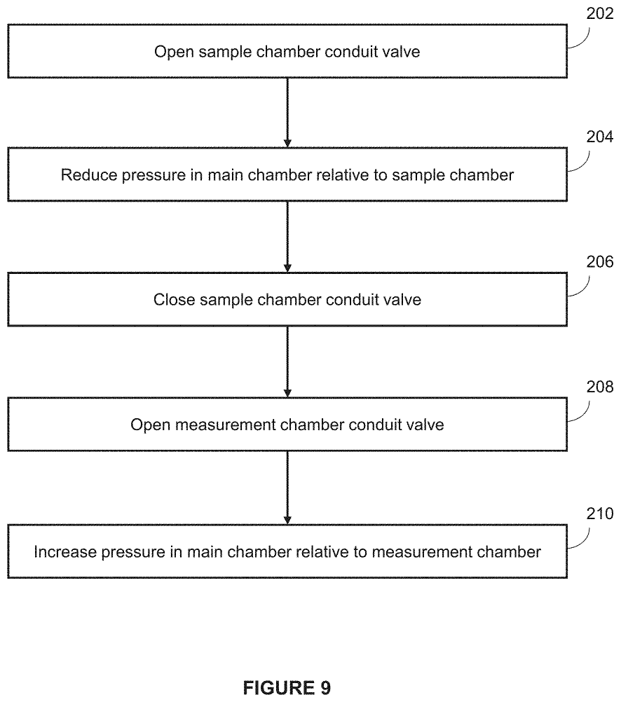

FIG. 9 illustrates a flow diagram for a method of operating any of the liquid handling devices 100 described above. The method is for transferring a sample from a sample chamber 104 to a main chamber 102 and then from the main chamber 102 to the one of the measurement chambers 106a/106b.

The method comprises opening 202 the sample chamber conduit valve 116; reducing 204 a pressure in the main chamber 102 relative to the sample chamber 104; closing 206 the sample chamber conduit valve 116; opening 208 one of the measurement chamber conduit valves 118a/118b; and increasing 210 a pressure in the main chamber 102 relative to the respective measurement chamber 106a/106b. The method may further comprise closing 236 the one of the measurement chamber conduit valves 118a/118b, although this is not essential.

As such, sample in the sample chamber 104 may be transferred from the sample chamber 104 to the main chamber 102, and then from the main chamber 102 to one of the measurement chambers 106a/106b.

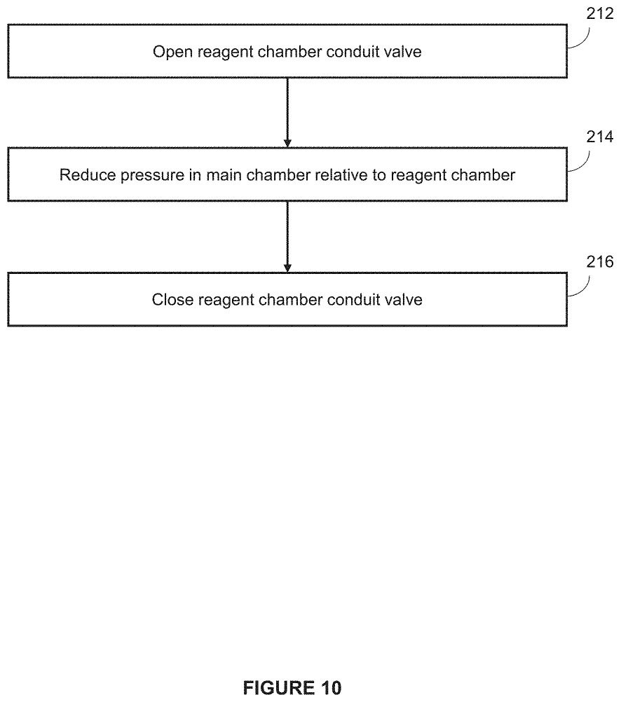

FIG. 10 illustrates a flow diagram for a method of operating any of the liquid handling devices 100 described above and comprising one or more reagent chambers 120a/b/c/d/e (including a dedicated reagent chamber 120c/120d and shared reagent chamber 120e). The method is for transferring a reagent from one of one or more reagent chambers 120a/b/c/d/e to the main chamber 102.

The method comprises opening 212 the reagent chamber conduit valve 124a/b/c/d/e corresponding to one of the one or more reagent chambers 120a/b/c/d/e; reducing 214 a pressure in the main chamber 102 relative to the one of the one or more reagent chambers 120a/b/c/d/e; and closing 216 the reagent chamber conduit valve 124a/b/c/d/e corresponding to the one of the one or more reagent chambers 120a/b/c/d/e.

As such, a reagent in one of the one or more reagent chambers 120a/120b may be transferred from the respective reagent chamber 120a/b/c/d/e to the main chamber 102.

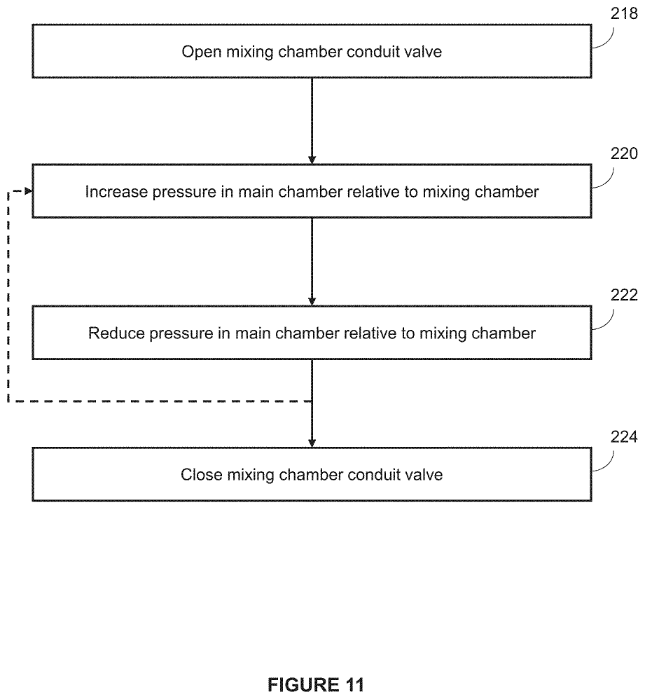

FIG. 11 illustrates a flow diagram for a method of operating any of the liquid handling devices 100 described above and comprising a mixing chamber 126. The method is for mixing liquids, such as a sample and a reagent, in the liquid handling device 100.

The method comprises opening 218 the mixing chamber conduit valve 130; increasing 220 a pressure in the main chamber 102 relative to the mixing chamber 126; reducing 222 a pressure in the main chamber 102 relative to the mixing chamber 126; and closing 224 the mixing chamber conduit valve 130.

As such, a mixture of liquids, such as a sample and a reagent, may be shuttled between the main chamber 102 and mixing chamber 126, thereby further mixing the liquids.

As also illustrated in FIG. 11, the method further comprises repeating increasing 220 a pressure in the main chamber 102 and reducing 222 a pressure in the main chamber 102 one or more times before closing 224 the mixing chamber conduit valve 130. This may further increase the degree of mixing of liquids in the liquid handling device, until the liquids are homogeneously mixed.

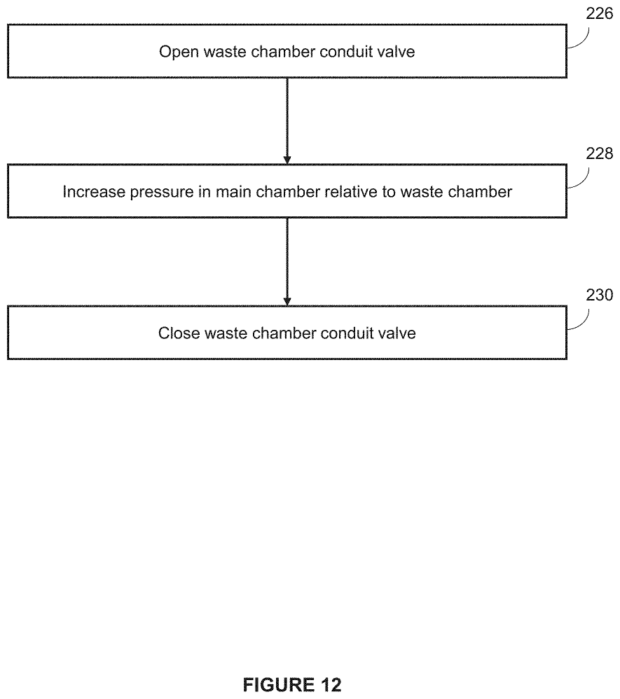

FIG. 12 illustrates a flow diagram for a method of operating any of the liquid handling devices 100 described above and comprising a waste chamber 132 and waste chamber conduit valve 136. The method is for transferring liquid in the main chamber 102 of the liquid handling device 100 to a waste chamber 132 where it can be safely stored.

The method comprises opening 226 the waste chamber conduit valve 136; increasing 228 a pressure in the main chamber 102 relative to the waste chamber 132; and closing 230 the waste chamber conduit valve 136.

As such, liquid in the main chamber 102 may be transferred to the waste chamber 132.

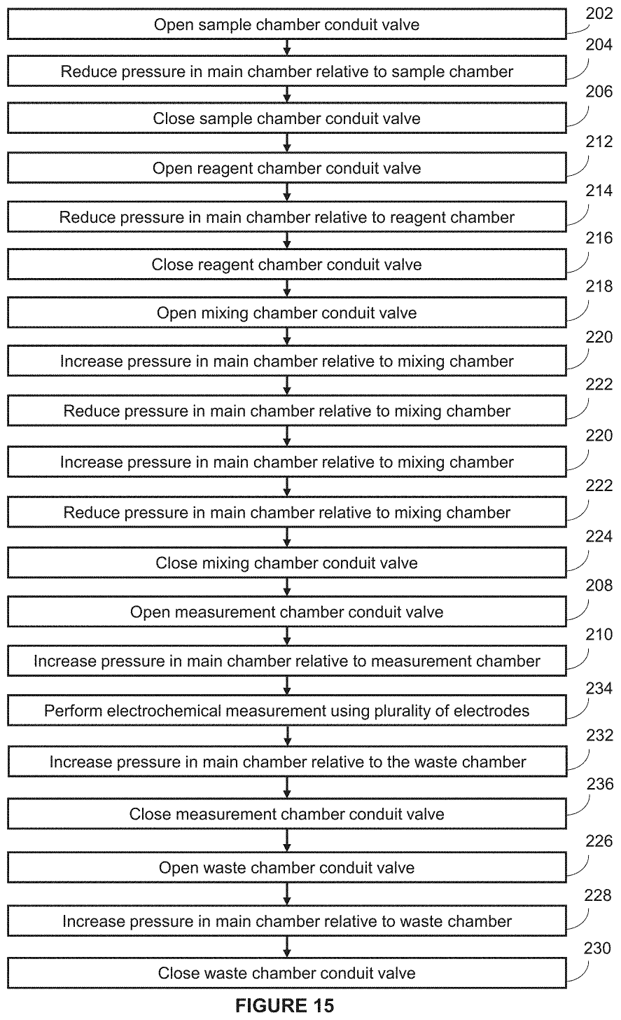

Also disclosed is a method of operating any of the liquid handling devices 100 described above and comprising a waste chamber 132 connected to the measurement chamber 138 via a waste chamber conduit 134a/134c, wherein the method comprises increasing 232 a pressure in the main chamber 102 relative to the waste chamber 132 after performing a measurement on the sample. The method is for transferring liquid in the measurement chamber 138 of the liquid handling device 100 to a waste chamber 132, where it can be safely stored after a measurement has been performed. This method is part of the method illustrated in the flow diagram of FIG. 15, discussed below, but does not need to be conducted in conjunction with the rest of the method illustrated in FIG. 15.

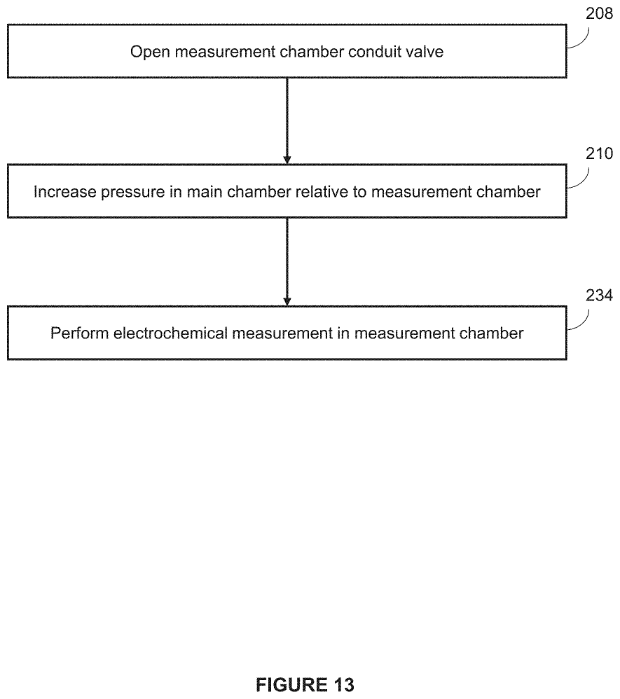

FIG. 13 illustrates a flow diagram for a method of operating any of the liquid handling devices 100 described above and comprising a plurality of electrodes 138 in a measurement chamber 106a/106b. The method comprises opening 208 the measurement chamber conduit valve 118a/118b corresponding to the respective measurement chamber 106a/106b; increasing 210 a pressure in the main chamber 102 relative to the respective measurement chamber 106a/106b; and performing 234 an electrochemical measurement on the sample using the plurality of electrodes 138. The method may comprise closing 236 the measurement chamber conduit valve 118a/118b before or after performing 234 the electrochemical measurement. The method is for performing a measurement on a sample as part of a diagnostic test.

The above-described methods can be performed in combination with each other, and in many different orders or multiple times, as required for a given diagnostic test. One method need not be completed before another method is performed.

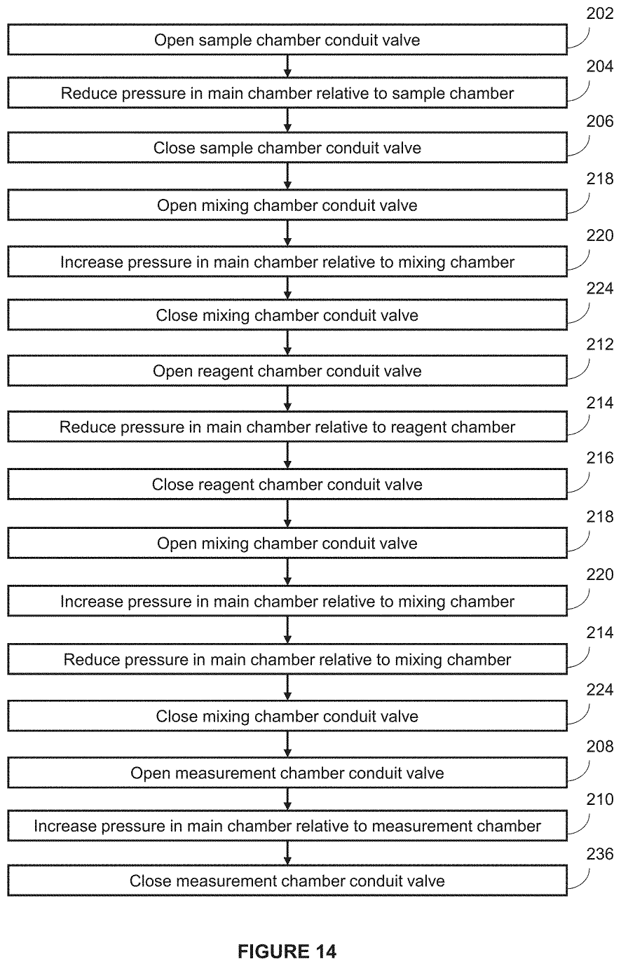

For example, FIG. 14 illustrates a flow diagram for a method of operating the liquid handling device 100 illustrated in FIG. 5, the method comprising a combination of the above-described methods. The method is for mixing a sample with a reagent and transferring it to a measurement chamber, where a measurement can be performed on the sample. The valves of the liquid handling device 100 are closed by default i.e. in a closed configuration unless opened as part of the method.

The method comprises:
a) opening 202 the sample chamber conduit valve 116;
b) reducing 204 a pressure in the main chamber 102 relative to the sample chamber 104;
c) closing 206 the sample chamber conduit valve 116;
d) opening 218 the mixing chamber conduit valve 130;
e) increasing 220 a pressure in the main chamber 102 relative to the mixing chamber 126;
f) closing 224 the mixing chamber conduit valve 130;
g) opening 212 the reagent chamber conduit valve 124a/b/c/d/e corresponding to one of the one or more reagent chambers 120a/b/c/d/e;
h) reducing 214 a pressure in the main chamber 102 relative to the one of the one or more reagent chambers 120a/b/c/d/e;
i) closing 216 the reagent chamber conduit valve 124a/b/c/d/e corresponding to the one of the one or more reagent chambers 120a/b/c/d/e;
j) opening 218 the mixing chamber conduit valve 130;
k) increasing 220 a pressure in the main chamber 102 relative to the mixing chamber 126;
l) reducing 222 a pressure in the main chamber 102 relative to the mixing chamber 126;
m) closing 224 the mixing chamber conduit valve 130;
n) opening 208 one of the respective measurement chamber conduit valves 118a/118b;
o) increasing 210 a pressure in the main chamber 102 relative to the respective measurement chamber 106a/106b; and
p) closing 236 one of the respective measurement chamber conduit valves 118a/118b.

When a sample has been inserted into the sample chamber 104 and the one of the one or more reagent chambers 120a/b/c/d/e comprises a reagent, the method achieves the following (each letter corresponding to the above method step with the same letter):
a) the sample chamber conduit valve 116 is opened;
b) the sample is transferred from the sample chamber 104 into the main chamber 102;
c) the sample chamber conduit valve 116 is closed;
d) the mixing chamber conduit valve 130 is opened;
e) the sample is transferred from the main chamber 102 into the mixing chamber 126;
f) the mixing chamber conduit valve 130 is closed;
g) the reagent chamber conduit valve 124a/b/c/d/e corresponding to one of the one or more reagent chambers 120a/b/c/d/e and holding the reagent is opened;
h) the reagent is transferred from the one of the one or more reagent chambers 120a/b/c/d/e into the main chamber 102;
i) the reagent chamber conduit valve 124a/b/c/d/e corresponding to the one of the one or more reagent chambers 120a/b/c/d/e is closed;
j) the mixing chamber conduit valve 130 is opened;
k) the reagent is transferred from the main chamber 102 into the mixing chamber 126—the mixing chamber 126 now comprises a mixture of the sample and the reagent;
l) the sample/reagent mixture is transferred into the main chamber 102 from the mixing chamber 126, increasing the homogeneity of the mixture;
m) the mixing chamber conduit valve 130 is closed;
n) one of the measurement chamber conduit valves 118a/118b is opened;
o) the sample/reagent mixture is transferred from the main chamber 102 into the respective measurement chamber 106a/106b; and
p) the one of the measurement chamber conduit valves 118a/118b is closed.

In another example combining the above-described method steps, FIG. 15 illustrates a flow diagram for a method of operating the liquid handling device 100 illustrated in FIG. 8. The method is for performing a measurement on a sample as part of a diagnostic test.

The valves of the liquid handling device 100 are closed by default i.e. in a closed configuration unless opened as part of the method.

The method comprises:
a) opening 202 the sample chamber conduit valve 116;
b) reducing 204 a pressure in the main chamber 102 relative to the sample chamber 104;
c) closing 206 the sample chamber conduit valve 116;
d) opening 212 the reagent chamber conduit valve 124a/b/c/d/e corresponding to one of the one or more reagent chambers 120a/b/c/d/e;
e) reducing 214 a pressure in the main chamber 102 relative to the one of the one or more reagent chambers 120a/b/c/d/e;
f) closing 216 the reagent chamber conduit valve 124a/b/c/d/e corresponding to the one of the one or more reagent chambers 120a/b/c/d/e;
g) opening 218 the mixing chamber conduit valve 130;
h) increasing 220 a pressure in the main chamber 102 relative to the mixing chamber 126;
i) reducing 222 a pressure in the main chamber 102 relative to the mixing chamber 126;
j) increasing 220 a pressure in the main chamber 102 relative to the mixing chamber 126;
k) reducing 222 a pressure in the main chamber 102 relative to the mixing chamber 126;
l) closing 224 the mixing chamber conduit valve 130;
m) opening 208 the second measurement chamber conduit valve 118b;
n) increasing 210 a pressure in the main chamber 102 relative to the second measurement chamber 106b;
o) performing 234 an electrochemical measurement using the plurality of electrodes 138 in the second measurement chamber 106b;
p) increasing 232 a pressure in the main chamber 102 relative to the second waste chamber 132b;
q) closing 236 the second measurement chamber conduit valve 118b;
r) opening 226 the waste chamber conduit valve 136;
s) increasing 228 a pressure in the main chamber 102 relative to the second waste chamber 132b; and
t) closing 230 the waste chamber conduit valve 136.

When a sample has been inserted into the sample chamber 104 and the one of the one or more reagent chambers 120a/b/c/d/e comprises a reagent, the method achieves the following (each letter corresponding to the above method step with the same letter):
a) the sample chamber conduit valve 116 is opened;
b) the sample is transferred from the sample chamber 104 into the main chamber 102;
c) the sample chamber conduit valve 116 is closed;
d) the reagent chamber conduit valve 124a/b/c/d/e corresponding to one of the one or more reagent chambers 120a/b/c/d/e and holding the reagent is opened;
e) the reagent from the one of the one or more reagent chambers 120a/b/c/d/e is transferred into the main chamber 102—the main chamber 102 now comprises a mixture of the sample and the reagent;
f) the reagent chamber conduit valve 124a/b/c/d/e corresponding to the one of the one or more reagent chambers 120a/b/c/d/e is closed;
g) the mixing chamber conduit valve 130 is opened;
h) the sample/reagent mixture is transferred from the main chamber 102 into to the mixing chamber 126, increasing the homogeneity of the mixture;
i) the sample/reagent mixture is transferred from the mixing chamber 126 into the main chamber 102, increasing the homogeneity of the mixture;
j) the sample/reagent mixture is transferred from the main chamber 102 into the mixing chamber 126, increasing the homogeneity of the mixture;
k) the sample/reagent mixture is transferred from the mixing chamber 126 into the main chamber 102, increasing the homogeneity of the mixture;
l) the mixing chamber conduit valve 130 is closed;
m) the second measurement chamber conduit valve 118b is opened;
n) a first portion of the sample/reagent mixture is transferred from the main chamber 102 into the second measurement chamber 106b, leaving a second portion of the sample/reagent mixture in the main chamber 102;
o) an electrochemical measurement is performed on the first portion of the sample/reagent mixture;
p) the first portion of the sample/reagent mixture in the second measurement chamber 106b is transferred into the second waste chamber 132b via the third waste chamber conduit 134c;
q) the second measurement chamber conduit valve 118b is closed;
r) the waste chamber conduit valve 136 is opened;
s) the second portion of the sample/reagent mixture in the main chamber 102 is transferred into the second waste chamber 132b via the second waste chamber conduit 134b; and
t) the waste chamber conduit valve 136 is closed to shut the first and second portions of the sample/reagent mixture in the second waste chamber 132b.

Also disclosed is a method of operating any of the liquid handling devices 100 described above and comprising pinch vales. The method comprises opening or closing at least one of the pinch valves by operating an actuator. The method is for opening and closing pinch valves of a liquid handling device 100.

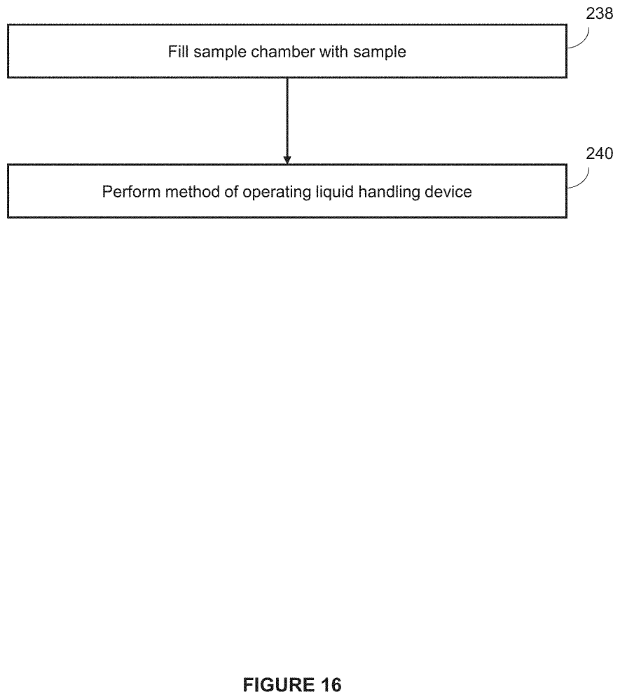

FIG. 16 illustrates a flow diagram for a method of performing a diagnostic test using any of the liquid handling devices 100 described above. The method comprises filling 238 the sample chamber 104 with a sample and performing 240 any of the above described methods.

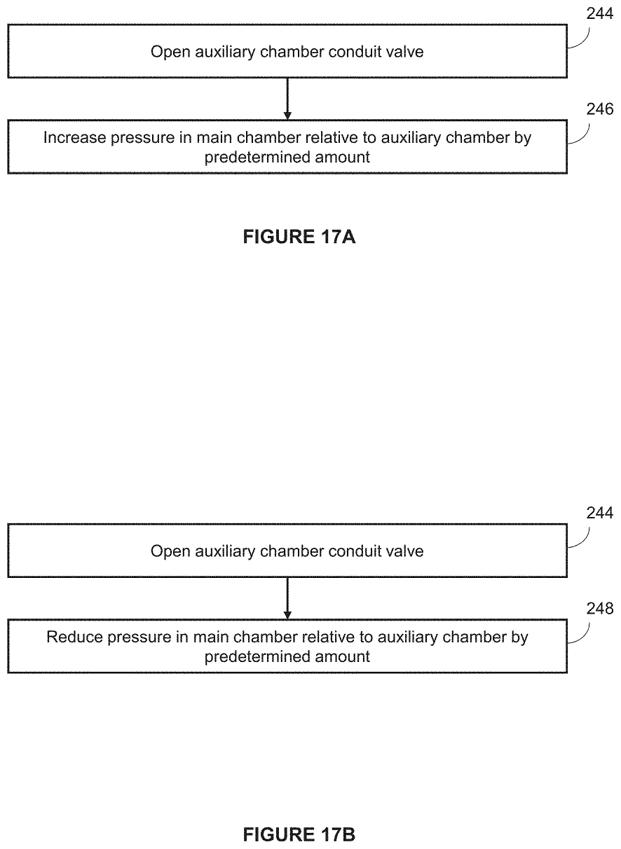

FIGS. 17A and 17B illustrate flow diagrams for methods of operating a liquid handling device 100, the liquid handling device comprising a main chamber 102; one or more auxiliary chambers; a respective auxiliary chamber conduit for each auxiliary chamber, wherein each auxiliary chamber conduit fluidically connects the respective auxiliary chamber to the main chamber 102; and a respective auxiliary chamber conduit valve for opening and closing each respective auxiliary chamber conduit. The method is for metering a volume of liquid (i.e. transferring a precise volume of liquid between chambers) by applying a predetermined pressure change for a predetermined period of time to the main chamber 102.

As illustrated in FIG. 17A, the method comprises opening 244 one of the auxiliary chamber conduit valves and increasing 246 the pressure in the main chamber 102 relative to the respective auxiliary chamber by a predetermined amount, thereby enabling transfer of a metered volume of a liquid from the main chamber 102 to the respective auxiliary chamber.

Alternatively, as illustrated in the flow diagram of FIG. 17B, the method comprises opening 244 one of the auxiliary chamber conduit valves and reducing 248 the pressure in the main chamber 102 relative to the respective auxiliary chamber by a predetermined amount, thereby enabling transfer of a metered volume of a liquid from the respective auxiliary chamber to the main chamber 102.

The one or more auxiliary chambers include at least one of a sample chamber 104, a reagent chamber 120a/b/c/d/e and a mixing chamber 126.

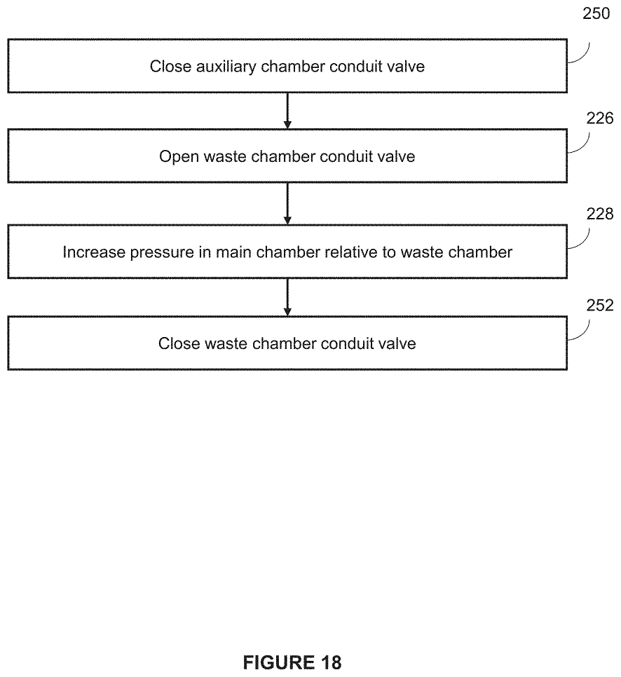

FIG. 18 illustrates a flow diagram for a method of operating a liquid handling device 100, performed after the methods illustrated in FIGS. 17A and 17B. The liquid handling device 100 further comprises a waste chamber 132; a waste chamber conduit 134, wherein the waste chamber conduit 134 fluidically connects the waste chamber 132 to the main chamber 102; and a waste chamber conduit valve 136 for opening and closing the waste chamber conduit 134, for example as illustrated in FIG. 6 or 7. The method further comprises closing 250 the one of the respective auxiliary chamber conduit valves; opening 226 the waste chamber conduit valve 136; increasing 228 a pressure in the main chamber 102 relative to the waste chamber 132 thereby enabling transfer of liquid in the main chamber 102 to the waste chamber 132; and closing 252 the one of the respective auxiliary chamber conduit valves.

As such, a first volume of a liquid may be overprovided to the main chamber 102, before a precise second volume of the liquid—less than the first volume—is transferred to an auxiliary chamber. The remainder of the first volume is then transferred to the waste chamber 132, and the precise second volume transferred to the main chamber 102. Thus, the imprecise first volume of liquid in the main chamber 102 is replaced by a precise second volume of liquid.

The methods for metering illustrated in FIGS. 17A, 17B and 18 (and their variations) may also be combined with the methods illustrated in FIGS. 9 to 16 (and their variations).

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g. for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

Thus, also disclosed is a computer program comprising computer-executable instructions which, when executed by a diagnostic system 300, cause the diagnostic system 300 to perform any of the methods described above.

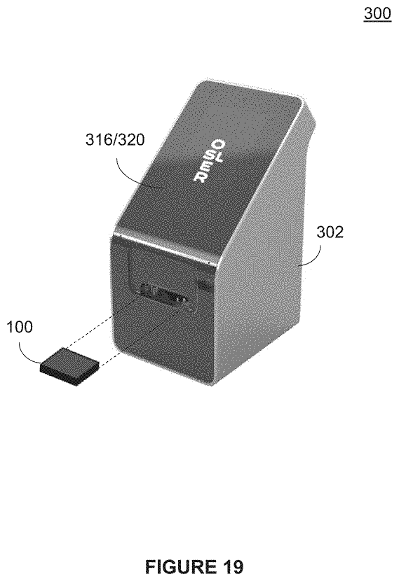

FIG. 19 illustrates a diagnostic system 300. The diagnostic system 300 comprises a liquid handling device 100, for example as illustrated in FIG. 8, and a docking station 302 for receiving the liquid handling device 100. The docking station 302 comprises a housing with a slot for receiving the liquid handling device 100. Inside the housing, the docking station includes a central bus structure, processor 304, data processing resources such as memory 306, variable pressure source 108, pressure source controller 308, actuator 310, actuator controller 312, display adapter 314, display device 316, one or more user-input device adapters 318, one or more user-input devices 320, such as a keyboard and/or a mouse, and one or more communications adapters 322. The display device 316 has touch-input functionality and so also functions as a user-input device 320.

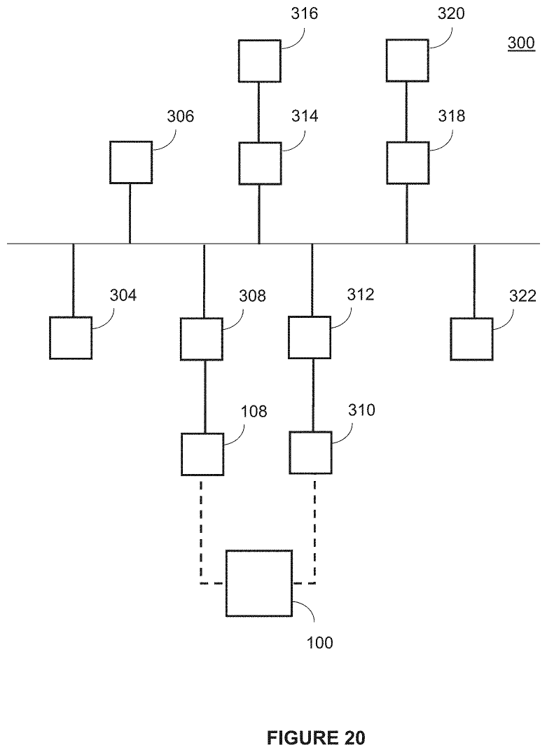

FIG. 20 illustrates a block diagram of the diagnostic system 300. The processor 304 is configured to execute the computer program which causes the diagnostic system 300 to perform any of the methods described above. The processor 304 is in communication with memory 306, which is for storing the computer program. The processor 304 and memory 306 are connected to the central bus structure inside the docking station 302.

The variable pressure source 108 is configured to connect to the liquid handling device 100. The processor 304 is configured to control the pressure source controller 308 to control the variable pressure source 108 in accordance with any of the above described methods. The variable pressure source 108 is a syringe pump and the pressure source controller 308 is a pump controller, although other pressure sources and pressure source controllers are known to the skilled person.

The system 300 comprises an electrovalve directly connected to the variable pressure source 108 in a separate pneumatic circuit. This is used as a venting valve to allow the variable pressure source 108 to be vented between consecutive operations.

The actuator 310 and actuator controller 312 are configured to selectively open or close each of the conduit valves of the liquid handling device 100, which are pinch valves. The processor 304 is configured to control the actuator 310 in accordance with any of the above described methods. The actuator 310 is a simple mechanical actuator that presses and releases the pinch valves to open and close them. Many other valve types and actuators are known to the skilled person.

The display adapter 314 is connected to the display device 316, the one or more user-input device adapters 318 are connected to the one or more user-input devices 320, and the one or more communications adapters 322 provide connections to other computer systems and networks. The pressure source controller 308, actuator controller 312, display adapter 314, user-input device adapters 318 and communications adapters 322 connect to the central bus structure. The system 300 may be provided without the display device 316 and display adapter 314.

Instead of the liquid handling device 100 illustrated in FIG. 8, the diagnostic system 300 may comprise any of the liquid handling devices 100 described above.

The embodiments of the invention shown in the drawings and described above are exemplary embodiments only and are not intended to limit the scope of the appended claims, including any equivalents as included within the scope of the claims. Various modifications are possible and will be readily apparent to the skilled person in the art. It is intended that any combination of non-mutually exclusive features described herein are within the scope of the present invention. That is, features of the described embodiments can be combined with any appropriate aspect described above and optional features of any one aspect can be combined with any other appropriate aspect.

1. A liquid handling device comprising:
a main chamber;
a sample chamber for receiving a sample;
one or more measurement chambers for performing measurements on the sample;
a variable pressure source conduit for connecting the main chamber to a variable pressure source;
a sample chamber conduit which fluidically connects the sample chamber to the main chamber;
a sample chamber conduit valve for opening and closing the sample chamber conduit;
a respective measurement chamber conduit for each measurement chamber, wherein each respective measurement chamber conduit fluidically connects the respective measurement chamber to the main chamber; and
a respective measurement chamber conduit valve for opening and closing each respective measurement chamber conduit.

2. A liquid handling device according to claim 1, wherein the main chamber is arranged to receive a fluid from the sample chamber when the sample chamber conduit valve is open and a negative pressure change is applied to the main chamber via the variable pressure source conduit, and the one or more measurement chambers are arranged to receive the fluid from the main chamber when the respective measurement chamber conduit valves are open and a positive pressure change is applied to the main chamber via the variable pressure source conduit.

3. A liquid handling device according to claim 1 or 2, further comprising:
one or more reagent chambers;
a respective reagent chamber conduit for each reagent chamber, wherein the respective reagent chamber conduit fluidically connects the respective reagent chamber to the main chamber; and
a respective reagent chamber conduit valve for opening and closing each respective reagent chamber conduit.

4. A liquid handling device according to any preceding claim, wherein the one or more measurement chambers comprise a first measurement chamber for performing a first measurement on the sample and a second measurement chamber for performing a second measurement on the sample, the liquid handling device further comprising:
a first respective measurement chamber conduit which fluidically connects the first measurement chamber to the main chamber;
a second respective measurement chamber conduit which fluidically connects the second measurement chamber to the main chamber;
a first respective measurement chamber conduit valve for opening and closing the first respective measurement chamber conduit; and
a second respective measurement chamber conduit valve for opening and closing the second respective measurement chamber conduit.

5. A liquid handling device according to claim 4 when dependent on claim 3, wherein the one or more reagent chambers comprise one or more first dedicated reagent chambers for reagents to be used only in a diagnostic test to be performed in the first measurement chamber, one or more second dedicated reagent chambers for reagents to be used only in a diagnostic test to be performed in the second measurement chamber, and one or more shared reagent chambers for reagents to be used in the diagnostic tests to be measured in both the first and second measurement chambers.

6. A liquid handling device according to claim 3 or claim 4 or 5 when dependent on claim 3, further comprising:
a mixing chamber for mixing the sample with a reagent from one of the one or more reagent chambers;
a mixing chamber conduit, wherein the mixing chamber conduit fluidically connects the mixing chamber to the main chamber; and
a mixing chamber conduit valve for opening and closing the mixing chamber conduit.

7. A liquid handling device according to any preceding claim, further comprising:
a waste chamber; and
a waste chamber conduit, wherein the waste chamber conduit fluidically connects the waste chamber to the main chamber.

8. A liquid handling device according to claim 7, further comprising a waste chamber conduit valve for opening and closing the waste chamber conduit.

9. A liquid handling device according to claim 7, wherein the waste chamber conduit fluidically connects the waste chamber to the main chamber via the measurement chamber.

10. A liquid handling device according to any preceding claim, wherein at least one of the one or more measurement chambers comprises a plurality of electrodes.

11. A liquid handling device according to any preceding claim, wherein each conduit valve is a pinch valve.

12. A liquid handling device according to claim 11, wherein the conduit valves are configured in a circular array of pinch valves.

13. A method of operating a liquid handling device according to any preceding claim, the method comprising:
opening the sample chamber conduit valve;
reducing a pressure in the main chamber relative to the sample chamber;
closing the sample chamber conduit valve;
opening one of the respective measurement chamber conduit valves; and
increasing a pressure in the main chamber relative to the respective measurement chamber.

14. A method according to claim 13, wherein the liquid handling device is in accordance with claim 3, the method further comprising:
opening the reagent chamber conduit valve corresponding to one of the one or more reagent chambers;
reducing a pressure in the main chamber relative to the one of the one or more reagent chambers; and
closing the reagent chamber conduit valve corresponding to the one of the one or more reagent chambers.

15. A method according to claim 13 or 14, wherein the liquid handling device is in accordance with claim 6, the method further comprising:
opening the mixing chamber conduit valve;
increasing a pressure in the main chamber relative to the mixing chamber;
reducing a pressure in the main chamber relative to the mixing chamber; and
closing the mixing chamber conduit valve.

16. A method according to claim 15, the method further comprising repeating increasing a pressure in the main chamber and reducing a pressure in the main chamber one or more times before closing the mixing chamber conduit valve.

17. A method according to any of claims 13 to 16, wherein the liquid handling device is in accordance with claim 8, the method further comprising:
opening the waste chamber conduit valve;
increasing a pressure in the main chamber relative to the waste chamber; and
closing the waste chamber conduit valve.

18. A method according to any of claims 13 to 17, wherein the liquid handling device is in accordance with claim 9, the method further comprising increasing a pressure in the main chamber relative to the waste chamber after performing a measurement on the sample.

19. A method according to any of claims 13 to 18, wherein the liquid handling device is in accordance with claim 10, the method further comprising performing an electrochemical measurement on the sample using the plurality of electrodes.

20. A method according to any of claims 13 to 19, wherein the liquid handling device is in accordance with claim 11, the method further comprising opening or closing at least one of the pinch valves by operating an actuator.

21. A method of performing a diagnostic test using a liquid handling device according to any of claims 1 to 12, the method comprising:
filling the sample chamber with a sample; and
performing a method according to any of claims 13 to 20.

22. A method according to claim 21, wherein the liquid handling device comprises one or more reagent chambers and each of the one or more reagent chambers comprises a respective reagent for the diagnostic test.

23. A method of operating a liquid handling device, wherein the liquid handling device comprises:
a main chamber;
one or more auxiliary chambers;
a respective auxiliary chamber conduit for each auxiliary chamber, wherein each auxiliary chamber conduit fluidically connects the respective auxiliary chamber to the main chamber; and
a respective auxiliary chamber conduit valve for opening and closing each respective auxiliary chamber conduit,
wherein the method comprises:
opening one of the respective auxiliary chamber conduit valves; and
increasing or reducing the pressure in the main chamber relative to the respective auxiliary chamber by a predetermined amount, thereby enabling transfer of a metered volume of a liquid between the main chamber and respective auxiliary chamber.

24. The method of claim 23, wherein the liquid handling device further comprises:
a waste chamber;
a waste chamber conduit, wherein the waste chamber conduit fluidically connects the waste chamber to the main chamber; and
a waste chamber conduit valve for opening and closing the waste chamber conduit,
wherein the method further comprises:
closing the one of the respective auxiliary chamber conduit valves;
opening the waste chamber conduit valve; and
increasing a pressure in the main chamber relative to the waste chamber thereby enabling transfer of liquid in the main chamber to the waste chamber.

25. A computer program comprising computer-executable instructions which, when executed by a system, cause the system to perform the method according to any of claims 13 to 24.

26. A system comprising a processor configured to execute the computer program according to claim 25.

27. A system according to claim 26, further comprising a variable pressure source configured to connect to a liquid handling device.

28. A system according to claim 26 or 27, when dependent on claim 20, further comprising an actuator configured to selectively open or close each of the pinch valves.

29. A system according to any of claims 26 to 28 further comprising the liquid handling device of any of claims 1 to 12.
